(19) United States
(12) Patent Application Publication
(10) Pub. No.: US 2018/0055276 A1
(43) Pub. Date: Mar. 1, 2018

(54) Hand Coffee Maker

(71) Applicant: Chung-Jen Chen, Taichung City (TW)

(72) Inventor: Chung-Jen Chen, Taichung City (TW)

(21) Appl. No.: 15/247,981

(22) Filed: Aug. 26, 2016

(51) Int. Cl. A47J 31/44; A47J 31/06; A47J 31/48

(52) U.S. Cl. CPC A47J 31/4428; A47J 31/48; A47J 31/06

(57) ABSTRACT

A hand coffee maker includes a rack, a filtering device, a placement dish and a water tray. The rack includes an upright sheet, an annular top seat connected with an upper end of the upright sheet, and an annular bottom seat connected with a lower end of the upright sheet. The top seat has a center provided with a circular hole for placing the filtering device. The top seat has an outer periphery provided with a plurality of outer grooves to allow passage of a user's fingers. The bottom seat has a center provided with a circular hole for placing the placement dish. The bottom seat has an inner periphery provided with a plurality of inner grooves to allow passage of a user's fingers. The water tray is placed on the placement dish.

### BACKGROUND OF THE INVENTION

### 1. Field of the Invention

The present invention relates to a coffee maker and, more particularly, to a hand coffee maker.

### 2. Description of the Related Art

A conventional hand coffee maker comprises an upper ring, a piece of strainer paper placed on the upper ring, and a plurality of foot stands extending downward from the upper ring. The upper ring is arranged at determined height by support of the foot stands. A coffee pot (or cup) is placed between the foot stands and located under the upper ring. After coffee powders are placed into the strainer paper, hot water from a spout is poured into the strainer paper which filters the coffee grounds so that the made coffee flows through the strainer paper and gradually drips into the coffee pot. However, the conventional hand coffee maker has a monotonous shape to decrease the aesthetic quality thereof so that it cannot attract the consumer's sight. In addition, after the coffee pot is removed, the residual coffee in the strainer paper still drips downward and will contact and dirt the table.

### BRIEF SUMMARY OF THE INVENTION

In accordance with the present invention, there is provided a hand coffee maker comprising a rack, a filtering device mounted on the rack, a placement dish mounted on the rack, and a water tray mounted on the placement dish. The rack includes an upright sheet, an annular top seat connected with an upper end of the upright sheet, and an annular bottom seat connected with a lower end of the upright sheet. The top seat of the rack has a center provided with a circular hole for placing the filtering device. The top seat of the rack has an outer periphery provided with a plurality of outer grooves to allow passage of a user's fingers. The bottom seat of the rack has a center provided with a circular hole for placing the placement dish. The bottom seat of the rack has an inner periphery provided with a plurality of inner grooves to allow passage of a user's fingers. The water tray is placed on the placement dish.

According to the primary advantage of the present invention, the upright sheet of the rack has different decorative designs, geometric shapes, artistic patterns, streaks, figures, trademarks, characters or a logos to enhance the aesthetic quality of the hand coffee maker and to provide an advertising effect.

According to another advantage of the present invention, the water tray collects the dripped coffee after the coffee pot is removed, to prevent the dripped coffee from being spilled outward, and to prevent the dripped coffee from contacting the table.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a partially perspective view of a hand coffee maker in accordance with the preferred embodiment of the present invention.

FIG. 2 is a perspective view of the hand coffee maker in accordance with the preferred embodiment of the present invention.

FIG. 3 is an exploded perspective view of the hand coffee maker as shown in FIG. 1.

FIG. 4 is a cross-sectional view of the hand coffee maker as shown in FIG. 2.

FIG. 5 is a cross-sectional view of the hand coffee maker taken along line B-B as shown in FIG. 4.

FIG. 6 is a schematic operational view of the hand coffee maker as shown in FIG. 1, showing the outer grooves of the top seat allowing passage of a user's fingers.

FIG. 7 is a perspective view of a hand coffee maker in accordance with another preferred embodiment of the present invention.

FIG. 8 is a schematic operational view of the hand coffee maker as shown in FIG. 1, showing the inner grooves of the bottom seat allowing passage of a user's fingers.

FIG. 9 is a schematic cross-sectional operational view of the hand coffee maker as shown in FIG. 2 in use.

FIG. 10 is a schematic cross-sectional operational view of the hand coffee maker as shown in FIG. 9, showing the coffee dripping into the water tray.

FIG. 11 is a cross-sectional view of the hand coffee maker taken along line M-M as shown in FIG. 10.

FIG. 12 is a schematic perspective operational view of a hand coffee maker in accordance with another preferred embodiment of the present invention.

FIG. 13 is a schematic perspective operational view of a hand coffee maker in accordance with another preferred embodiment of the present invention.

### DETAILED DESCRIPTION OF THE INVENTION

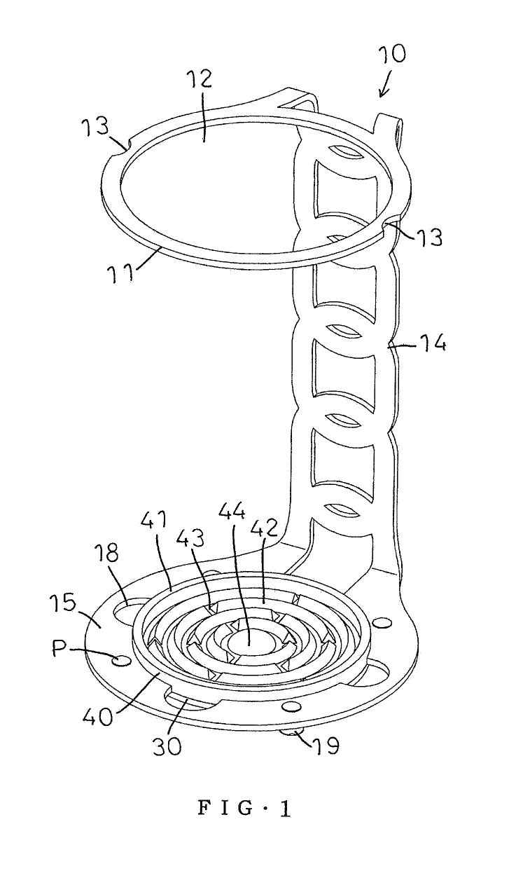

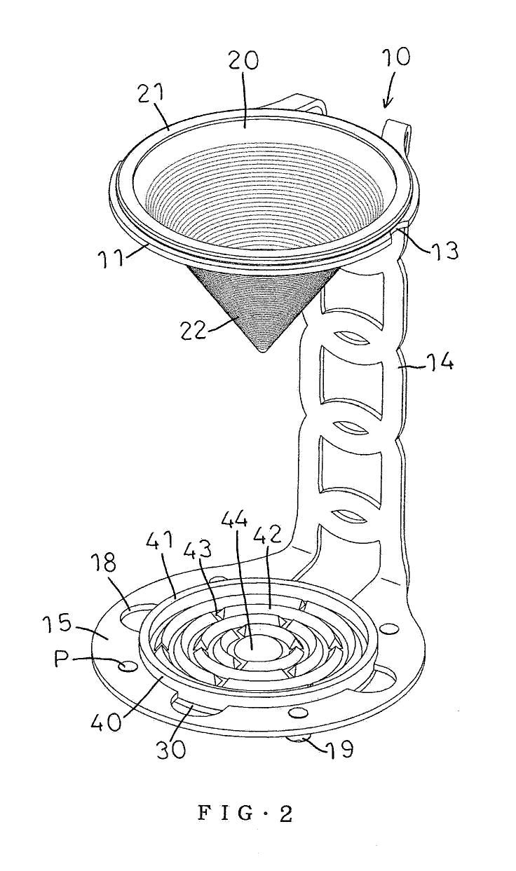

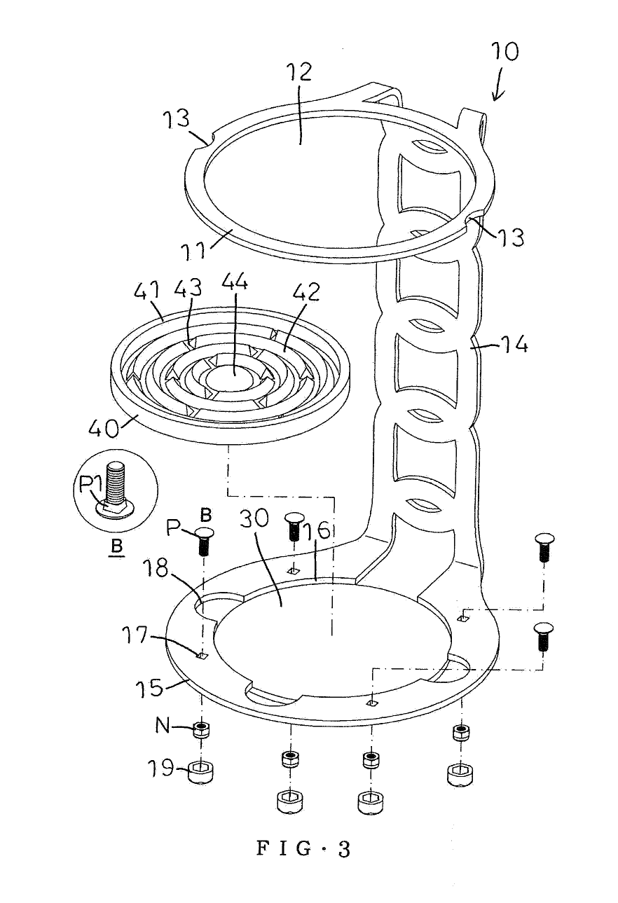

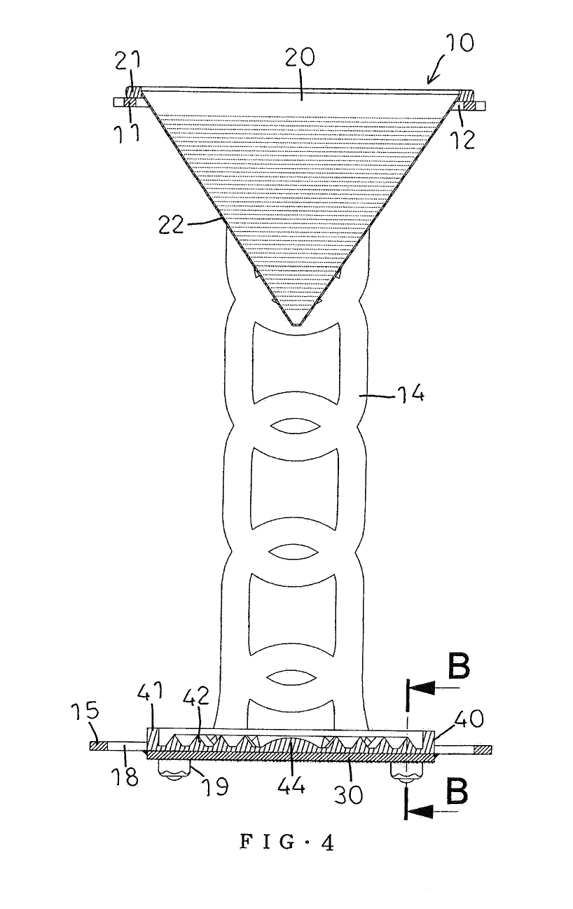

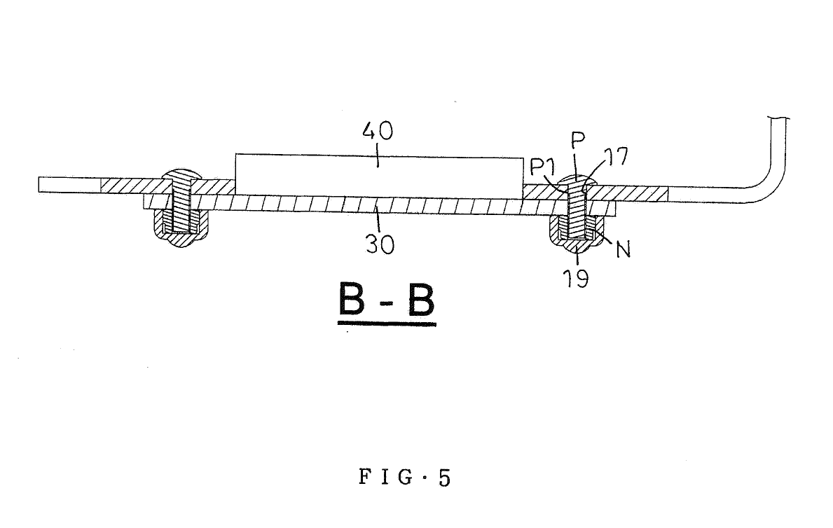

Referring to the drawings and initially to FIGS. 1-5, a hand coffee maker in accordance with the preferred embodiment of the present invention comprises a rack 10, a filtering device 20 mounted on the rack 10, a placement dish 30 mounted on the rack 10, and a water tray 40 mounted on the placement dish 30.

The rack 10 includes an upright sheet 14, an annular top seat 11 connected with an upper end of the upright sheet 14, and an annular bottom seat 15 connected with a lower end of the upright sheet 14 and spaced from the top seat 11. The top seat 11 of the rack 10 is arranged in a horizontal manner and has a center provided with a circular hole 12 for placing the filtering device 20. The top seat 11 of the rack 10 has an outer periphery provided with a plurality of arcuate outer grooves 13 to allow passage of a user's fingers. The bottom seat 15 of the rack 10 is arranged in a horizontal manner and has a center provided with a circular hole 16 for placing the placement dish 30. The bottom seat 15 of the rack 10 has an inner periphery provided with a plurality of semi-circular inner grooves 18 to allow passage of a user's fingers. The placement dish 30 is secured in the circular hole 16 of the bottom seat 15 by soldering. Preferably, the placement dish 30 has an outer diameter equal to an inner diameter of the circular hole 16 of the bottom seat 15. The water tray 40 is placed on the placement dish 30.

In the preferred embodiment of the present invention, the upright sheet 14 has different decorative designs, geometric shapes, artistic patterns, streaks, figures, trademarks, characters or a logos.

In the preferred embodiment of the present invention, the filtering device 20 is made of paper, cloth or metallic material, and has a conic shape with a wider upper portion and a narrower lower portion. The filtering device 20 has a top having a periphery provided with a protruding edge 21 placed on a peripheral face of the top seat 11 of the rack 10. The filtering device 20 has a surface provided with a plurality of net holes 22 for filtering coffee grounds, so that coffee infiltrates through the net holes 22 and drips from a pointed bottom of the filtering device 20.

In the preferred embodiment of the present invention, the bottom seat 15 of the rack 10 has a surface provided with a plurality of square through holes 17, and the hand coffee maker further comprises a plurality of screws “P” extending through the through holes 17 of the bottom seat 15, a plurality of nuts “N” screwed onto the screws “P”, and a plurality of foot pads 19 secured on the nuts “N”. The rack 10 is placed on a table steadily by the foot pads 19. Each of the screws “P” is provided with a square fixing portion “P1” secured in each of the through holes 17 of the bottom seat 15 so that each of the screws “P” is non-rotatable relative to the bottom seat 15 of the rack 10.

In the preferred embodiment of the present invention, the water tray 40 has an outer diameter equal to an inner diameter of the circular hole 16 of the bottom seat 15. The water tray 40 has a periphery provided with a stop flange 41 which defines a water dripping space in an interior of the water tray 40. The water tray 40 has a center provided with a semi-spherical projection 44 which has a height smaller than that of the stop flange 41. The water tray 40 has a surface provided with a plurality of annular ridges 42 arranged in a concentric manner. Each of the annular ridges 42 has a height smaller than that of the stop flange 41. Each of the annular ridges 42 is provided with a plurality breaches 43, and the breaches 43 of the annular ridges 42 are connected, so that dripped coffee flows through the projection 44 into the water dripping space of the water tray 40 and flows between the breaches 43 of the annular ridges 42. Preferably, Each of the annular ridges 42 has a substantially triangular cross-sectional profile.

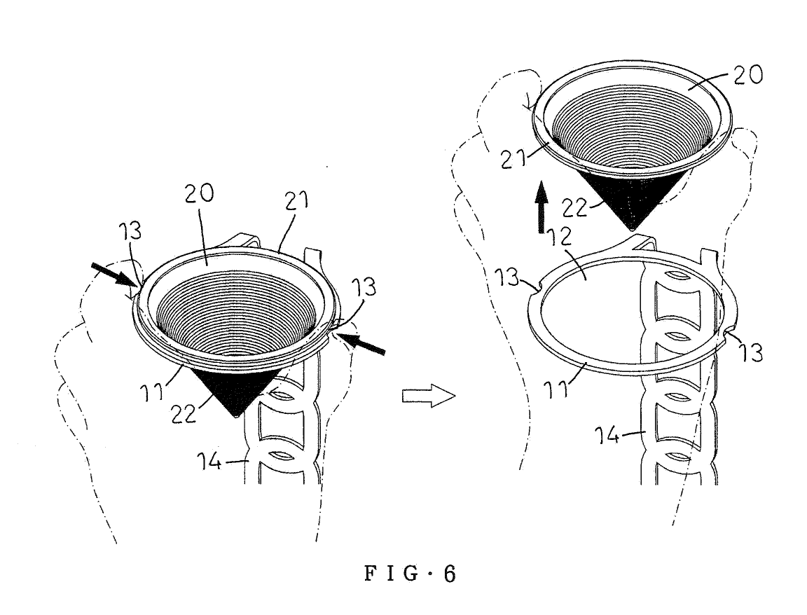

As shown in FIG. 6, when the filtering device 20 is placed on the top seat 11, the outer grooves 13 of the top seat 11 allow passage of a user's fingers so as to hold and remove the filtering device 20 from the top seat 11.

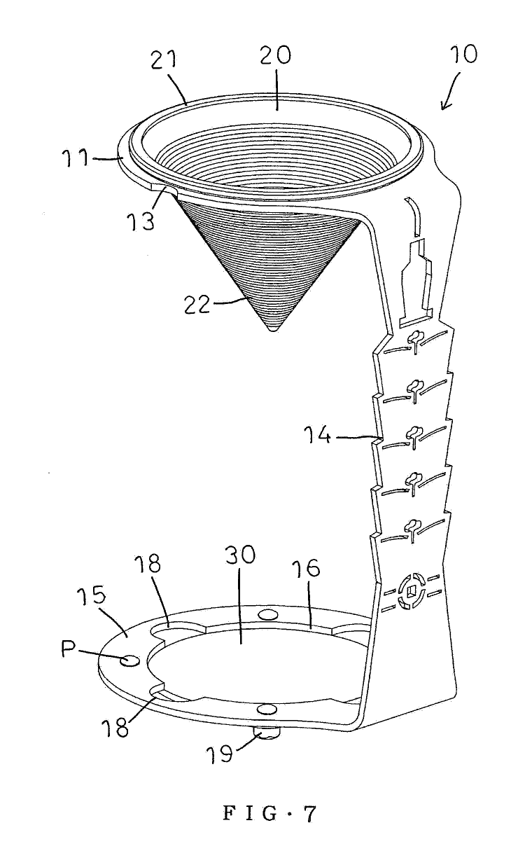

As shown in FIG. 7, the upright sheet 14 of the rack 10 has the shape of an outstanding building, such as the 101 building of Taipei.

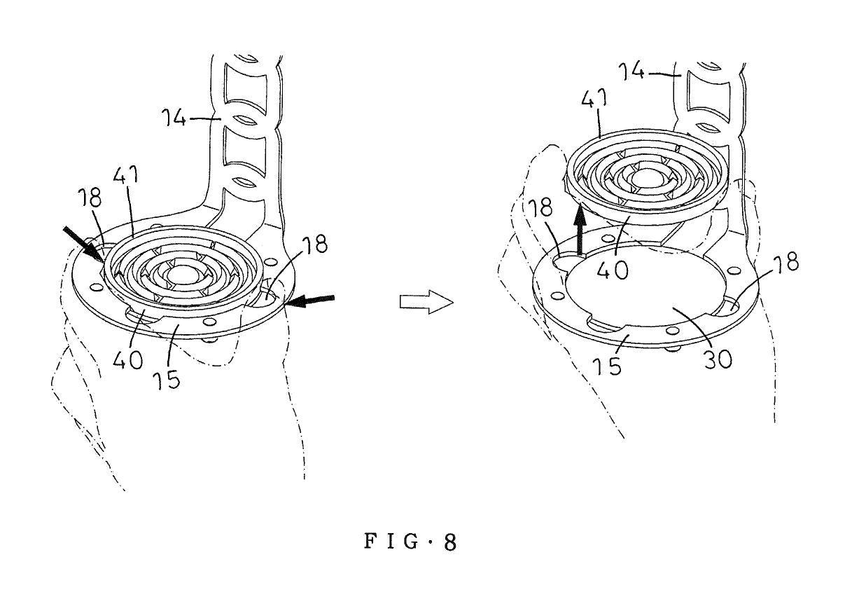

As shown in FIG. 8, when the water tray 40 is placed on the placement dish 30 which is placed on the bottom seat 15, the inner grooves 18 of the bottom seat 15 allow passage of a user's fingers so as to hold and remove the water tray 40 from the placement dish 30 and the bottom seat 15.

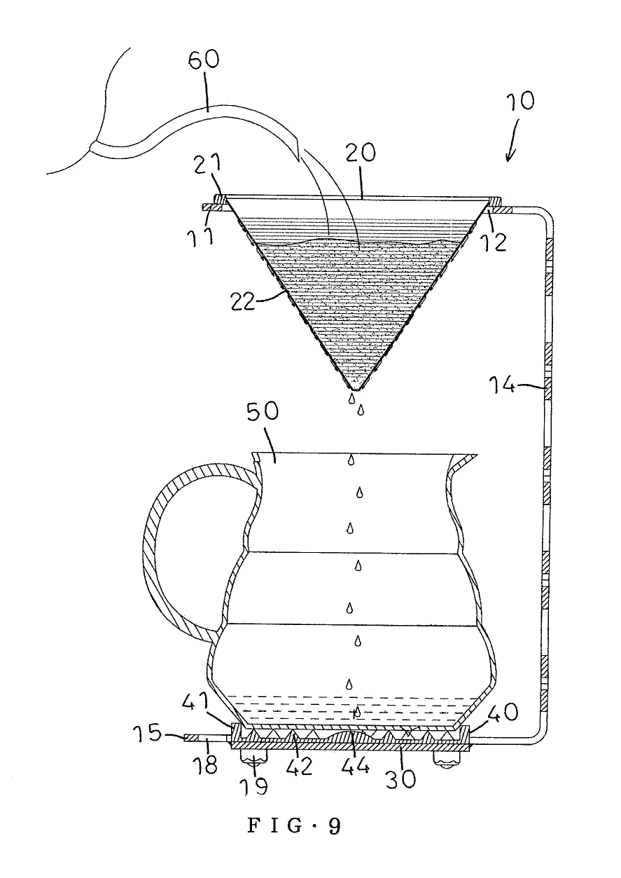

As shown in FIG. 9, the filtering device 20 is placed on the top seat 11, and a coffee pot 50 is placed on the water tray 40 and located under the filtering device 20. At this time, the stop flange 41 of the water tray 40 stops the bottom of the coffee pot 50 to prevent the coffee pot 50 from upsetting. In addition, the annular ridges 42 of the water tray 40 provide an antiskid effect to the coffee pot 50 and prevent the bottom of the coffee pot 50 from contacting the coffee. Then, coffee powders are placed in the filtering device 20, and hot water from a spout 60 is gradually poured into the filtering device 20 to make coffee. In such a manner, after the coffee grounds are filtered by the net holes 22 of the filtering device 20, the coffee infiltrates through the net holes 22 and drips from the pointed bottom of the filtering device 20 into the coffee pot 50.

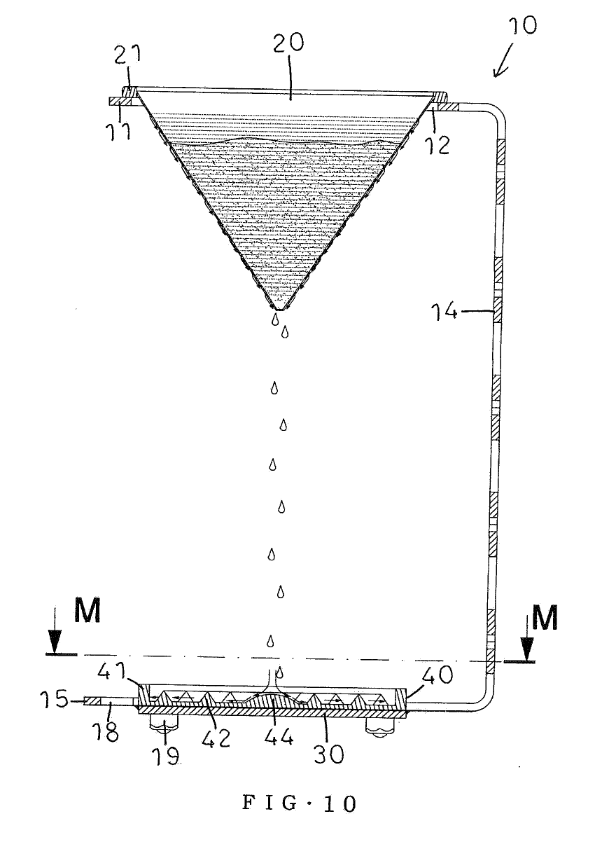

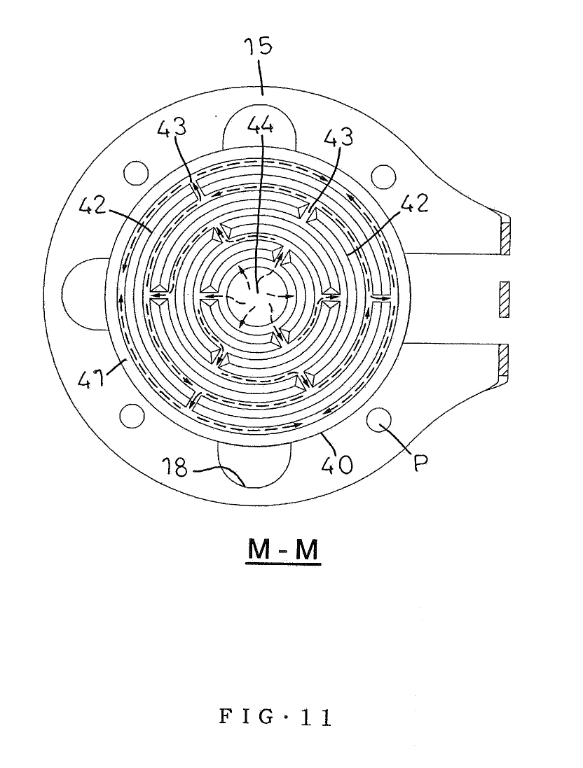

As shown in FIGS. 10 and 11, after the coffee pot 50 is removed, the coffee drips into the water tray 40. At this time, the dripped coffee flows through the projection 44 into the water dripping space of the water tray 40 and flows between the breaches 43 of the annular ridges 42. Thus, the water tray 40 limits the dripped coffee to prevent the dripped coffee from being spilled outward.

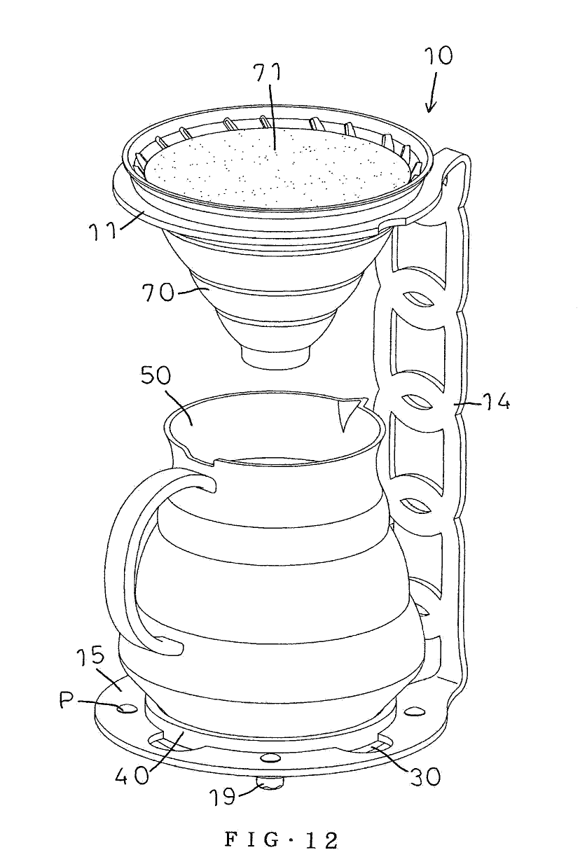

As shown in FIG. 12, a strainer cup 70 is placed on the top seat 11 of the rack 10, and a piece of filtering paper 71 is placed on the top of the strainer cup 70 to filter the fat contained in the coffee.

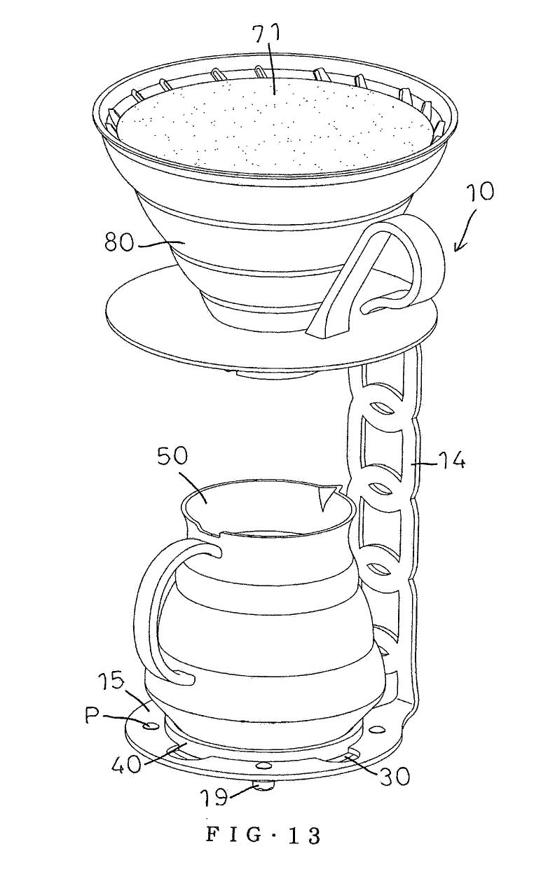

As shown in FIG. 13, a conic strainer cup 80 is placed on the top seat 11 of the rack 10, and the filtering paper 71 is placed on the top of the conic strainer cup 80 to filter the fat contained in the coffee.

Accordingly, the upright sheet 14 of the rack 10 has different decorative designs, geometric shapes, artistic patterns, streaks, figures, trademarks, characters or a logos to enhance the aesthetic quality of the hand coffee maker and to provide an advertising effect. In addition, the water tray 40 collects the dripped coffee after the coffee pot 50 is removed, to prevent the dripped coffee from being spilled outward, and to prevent the dripped coffee from contacting the table.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A hand coffee maker comprising:
a rack;
a filtering device mounted on the rack;
a placement dish mounted on the rack; and
a water tray mounted on the placement dish;
wherein:
the rack includes an upright sheet, an annular top seat connected with an upper end of the upright sheet, and an annular bottom seat connected with a lower end of the upright sheet;
the top seat of the rack has a center provided with a circular hole for placing the filtering device;
the top seat of the rack has an outer periphery provided with a plurality of outer grooves to allow passage of a user's fingers;
the bottom seat of the rack has a center provided with a circular hole for placing the placement dish;
the bottom seat of the rack has an inner periphery provided with a plurality of inner grooves to allow passage of a user's fingers; and
the water tray is placed on the placement dish.

2. The hand coffee maker of claim 1, wherein the upright sheet has different decorative designs, geometric shapes, artistic patterns, streaks, figures, trademarks, characters or a logos.

3. The hand coffee maker of claim 1, wherein:
the filtering device is made of paper, cloth or metallic material, and has a conic shape with a wider upper portion and a narrower lower portion;
the filtering device has a top having a periphery provided with a protruding edge placed on a peripheral face of the top seat of the rack; and
the filtering device has a surface provided with a plurality of net holes.

4. The hand coffee maker of claim 1, wherein:
the bottom seat of the rack has a surface provided with a plurality of square through holes;
the hand coffee maker further comprises a plurality of screws extending through the through holes of the bottom seat, a plurality of nuts screwed onto the screws, and a plurality of foot pads secured on the nuts; and
each of the screws is provided with a square fixing portion secured in each of the through holes of the bottom seat so that each of the screws is non-rotatable relative to the bottom seat of the rack.

5. The hand coffee maker of claim 1, wherein:
the water tray has an outer diameter equal to an inner diameter of the circular hole of the bottom seat;
the water tray has a periphery provided with a stop flange which defines a water dripping space in an interior of the water tray;
the water tray has a center provided with a semi-spherical projection which has a height smaller than that of the stop flange;
the water tray has a surface provided with a plurality of annular ridges arranged in a concentric manner;
each of the annular ridges has a height smaller than that of the stop flange;
each of the annular ridges is provided with a plurality breaches; and
the breaches of the annular ridges are connected.

6. The hand coffee maker of claim 5, wherein each of the annular ridges has a substantially triangular cross-sectional profile.
